(19) United States
(12) Patent Application Publication
(10) Pub. No.: US 2026/0260623 A1
(43) Pub. Date: Sep. 3, 2026

(54) DISPLAY DEVICE

(71) Applicant: LG Display Co., Ltd., Seoul (KR)

(72) Inventor: Sang Hyun PARK, Paju-si (KR)

(73) Assignee: LG Display Co., Ltd., Seoul (KR)

(21) Appl. No.: 19/552,456

(22) Filed: Feb. 27, 2026

(30) Foreign Application Priority Data
Feb. 28, 2025 (KR) 10-2025-0026578

(51) Int. Cl. G09G 3/3266; G09G 3/3233; G09G 3/3275

(52) U.S. Cl. CPC G09G 3/3266; G09G 3/3233; G09G 3/3275; G09G 2300/0819; G09G 2300/0842; G09G 2310/027; G09G 2310/0286; G09G 2310/0289; G09G 2310/0297; G09G 2310/08; G09G 2320/0233; G09G 2330/021

(57) ABSTRACT

A disclosed display device includes a display panel in which a plurality of data lines, a plurality of gate lines, a plurality of reference lines, and a plurality of sub-pixels are disposed; a data driver connected to the plurality of data lines and the plurality of reference lines; a gate driver connected to the plurality of gate lines; a level shifter configured to output a gate clock signal to the gate driver; and a timing controller configured to control the data driver and the gate driver, in which the level shifter is configured to output the gate clock signal with an adjusted pulse width to the gate driver according to a deviation in resistance between the reference lines respectively to which the plurality of sub-pixels are connected.

### CROSS-REFERENCE TO RELATED APPLICATION

This application claims priority to and the benefit of Korean Patent Application No. 10-2025-0026578, filed Feb. 28, 2025, the disclosure of which is incorporated herein by reference in its entirety.

### BACKGROUND

### Field

Embodiments of the present disclosure relate to a display device with improved image quality.

### Discussion of Related Art

Various flat panel displays such as a liquid crystal display and an electroluminescence display are known. An electroluminescence display uses a light-emitting element disposed in each of pixels to emit light by itself without a backlight and can display an input image. The light-emitting elements of the electroluminescence displays may be categorized into an organic light-emitting element and an inorganic light-emitting element according to a material for a light-emitting layer. An active matrix type organic light-emitting display device has advantages of a high response speed, high light emission efficiency, high luminance, and a wide viewing angle due to having an organic light-emitting diode (hereinafter, referred to as “OLED”) emitting light by itself disposed in each pixel. The active matrix type organic light-emitting display device is also excellent in contrast ratio and color reproducibility because a black grayscale can be expressed as complete black.

A plurality of sub-pixels may emit light when a data voltage is applied by a data driver. Because reference lines between a plurality of sub-pixels and the data driver have a deviation in resistance, a gate-source voltage of a driving transistor of each sub-pixel may be different, resulting in luminance nonuniformity.

### SUMMARY

Embodiments of the present disclosure provide, for example, a display device in which luminance uniformity among a plurality of sub-pixels is improved.

Embodiments of the present disclosure provide, for example, a display device capable of sensing a deviation in resistance between a sub-pixel disposed at a center of a data driving element and a sub-pixel disposed at an edge in the data driving element.

The problems addressed by various embodiments of the present disclosure and the objects of the present disclosure are not limited to those described above, and other addressed problems and objects not described can be clearly understood by those skilled in the art from the following description.

To achieve these objects and other advantages of the present disclosure, as embodied and broadly described herein, a display device according to one or more example embodiments of the present disclosure includes a display panel in which a plurality of data lines, a plurality of gate lines, a plurality of reference lines, and a plurality of sub-pixels are disposed; a data driver connected to the plurality of data lines and the plurality of reference lines; a gate driver connected to the plurality of gate lines; a level shifter configured to output a gate clock signal to the gate driver; and a timing controller configured to control the data driver and the gate driver, in which the level shifter is configured to output the gate clock signal with an adjusted pulse width to the gate driver according to a deviation in resistance between the reference lines respectively to which the plurality of sub-pixels are connected.

In one or more example embodiments, the plurality of sub-pixels may include a first sub-pixel connected to a reference line disposed on an outermost side among a plurality of reference lines connected to a data driving element of the data driver, and a second sub-pixel connected to another reference line disposed at a most center among the plurality of reference lines, and the timing controller may be further configured to output a control signal to the level shifter such that the pulse width of the gate clock signal is adjusted according to a deviation in resistance between the reference lines respectively to which the first sub-pixel and the second sub-pixel are connected.

In one or more example embodiments, the timing controller may be further configured to output a control signal to the level shifter such that a rising edge timing of the gate clock signal is adjusted.

In one or more example embodiments, each of the sub-pixels may include a driving transistor having a first node and a second node connected to a light-emitting element, a first transistor between the first node of the driving transistor and a corresponding data line among the plurality of data lines; a second transistor connected to the second node of the driving transistor and a corresponding reference line among the plurality of reference lines; a storage capacitor connected between the first node and the second node; a first reference voltage switch configured to apply a reference voltage for driving to the corresponding reference line; and a second reference voltage switch configured to apply a reference voltage for sensing to the corresponding reference line.

In one or more example embodiments, during an operation in a reference line sensing mode, the sub-pixel may include an initialization period during which a reference voltage for driving at a first voltage level is charged in the second node, a floating period during which a reference voltage for driving at a second voltage level lower than the first voltage level is charged in the corresponding reference line to float the corresponding reference line, and a sensing period during which the second node and the corresponding reference line are electrically connected to sense a voltage of the corresponding reference line.

In one or more example embodiments, in the initialization period, the first reference voltage switch and the second transistor may be turned on to apply the reference voltage for driving at the first voltage level to the second node.

In one or more example embodiments, a data voltage for sensing may be applied to the first node in the initialization period, and the first voltage level may be higher than the data voltage for sensing.

In one or more example embodiments, in the floating period, the second transistor may be turned off, and after the reference voltage for driving is changed to the second voltage level and charged in the corresponding reference line, the first reference voltage switch may be turned off.

In one or more example embodiments, the second voltage level may be higher than the reference voltage for sensing.

In one or more example embodiments, in the sensing period, the second transistor may be turned on to connect the second node and the corresponding reference line, and, a sensing voltage charged in a sensing capacitor of the corresponding reference line may be different according to a magnitude of resistance of the corresponding reference line.

In one or more example embodiments, the display device may further include a power supply configured to apply the reference voltage for driving to the data driver, in which the timing controller may be further configured to apply a control signal to the power supply such that the power supply changes a voltage level of the reference voltage for driving in the floating period.

In one or more example embodiments, the timing controller may be further configured to increase the pulse width of the gate clock signal when a deviation in sensing voltage between the reference lines respectively to which the first sub-pixel and the second sub-pixel are connected is greater than a predetermined deviation.

In one or more example embodiments, the display device may further include a memory configured to store a deviation critical value and pulse width information of the gate clock signal, in which the timing controller may be further configured to increase the pulse width of the gate clock signal according to the pulse width information stored in the memory when the deviation in sensing voltage between the reference lines respectively to which the first sub-pixel and the second sub-pixel are connected is greater than the deviation critical value.

According to one or more embodiments of the present disclosure, it is possible to reduce a luminance difference among a plurality of sub-pixels to prevent or suppress a problem that vertical stripes are visible at regular intervals.

Further, according to one or more embodiments of the present disclosure, it is possible to sense a charging deviation of a gate-source voltage between a sub-pixel disposed at the center of the data driving element and a sub-pixel disposed at the edge of the data driving element, and as a result, it is possible to adjust the width of the gate clock signal to reduce the charging deviation of the gate-source voltage.

The effects of the present disclosure are not limited to the effects described above, and other effects not described can be understood by those skilled in the art from the following description and the appended claims.

### BRIEF DESCRIPTION OF THE DRAWINGS

The accompanying drawings, which are included to provide a further understanding of the present disclosure and are incorporated in and constitute a part of this application, illustrate various example embodiments of the present disclosure and together with the description serve to explain various principles of the disclosure. In the drawings:

FIG. 1 is a block diagram showing a display device according to an example embodiment of the present disclosure;

FIG. 2 is a diagram showing an example of a sensing period;

FIG. 3 is a diagram showing the display device according to an example embodiment of the present disclosure;

FIG. 4 is a diagram showing an example of a plurality of reference lines connected to a source driver having different lengths;

FIG. 5 is a circuit diagram showing a sensing part electrically connected to a pixel circuit according to an example embodiment of the present disclosure;

FIGS. 6 to 8 are diagrams showing a process of sensing a reference line according to an example embodiment of the present disclosure;

FIG. 9 is a waveform chart of gate signals and voltages that are input to pixel circuits of a first sub-pixel and a second sub-pixel according to an example embodiment of the present disclosure;

FIG. 10 is a diagram showing a connection structure of a timing controller, a level shifter, a gate driving circuit, and a display panel according to an example embodiment of the present disclosure;

FIG. 11 is a diagram showing an example state in which resistance deviation between the first sub-pixel and the second sub-pixel is prevented or reduced when a width of a gate clock is increased; and

FIG. 12 is a waveform chart showing waveforms of gate clock signals according to an example embodiment of the present disclosure.

### DETAILED DESCRIPTION

The advantages and features of the present disclosure, and methods of achieving them will be apparent from example embodiments described in detail below in conjunction with the accompanying drawings. The present disclosure is not limited to the following example embodiments, which may be implemented in various different forms; rather, the example embodiments are provided to make the description of the present disclosure more complete and to allow those skilled in the art to more fully understand the features and aspects of the present disclosure. A protected scope of the present disclosure may be defined with the appended claims and their equivalents.

The shapes, sizes, proportions, angles, numbers and the like shown in the accompanying drawings for the purpose of describing example embodiments of the present disclosure are merely examples, and the present disclosure is not limited thereto. Like reference numerals generally denote like elements throughout the present specification unless otherwise specified. Further, in describing the present disclosure, detailed descriptions of known related technologies may be omitted so as not to unnecessarily obscure the subject matter of the present disclosure.

The terms such as “comprising,” “including,” “having,” and “consisting of” used herein are generally intended to allow other components to be added unless the terms are used with a more specific term like “only.” References to the singular shall be construed to include the plural, and vice versa, unless expressly stated otherwise.

In the interpretation of components, they are to be construed to include margins of error, even if not explicitly stated.

Where a positional or interconnected relationship between two components is described with such terms as “on top of,” “above,” “below,” “next to,” “connect or couple with,” “crossing,” “intersecting,” etc., one or more other components may be interposed between them unless a more specific term like “immediately” or “directly” is used.

Where a temporal contextual relationship is described with a term like “after,” “following,” “next to,” or “before,” it may not be continuous on a time scale unless a more specific term like “immediately” or “directly” is used.

Such terms as “first,” “second,” and so on may be used to describe various components, but the components are not limited by these terms. The functions or structures of these components are not limited to the ordinal number or component name attached to the component. These terms are used merely to refer to one component separately from another. Accordingly, a “first” component can also be referred to as a “second” component, and vice versa, within the technical spirit of the present disclosure.

The following embodiments may be combined or associated with each other in whole or in part, and various types of interlocking and driving are technically possible. The embodiments may be implemented independently of one another or may be implemented together in an interrelated relationship.

In the display device according to example embodiments of the present disclosure, the pixel circuit may include a plurality of transistors. The transistors may be implemented as an oxide thin film transistor (TFT) including an oxide semiconductor or a low temperature poly silicon TFT (LTPS TFT) including a low temperature poly silicon (LTPS).

A transistor is a three-electrode element including a gate, a source, and a drain. The source is an electrode that supplies carriers to the transistor. In the transistor, the carriers start to flow from the source. The drain is an electrode through which the carriers exit in the transistor. In the transistor, the carriers flow from the source to the drain. In the case of an n-channel transistor, since the carriers are electrons, a source voltage is lower than a drain voltage, allowing the electrons to flow from the source to the drain. In the n-channel transistor, the direction of current is from the drain to the source. In the case of a p-channel transistor, since the carriers are holes, a source voltage is higher than a drain voltage such that the holes can flow from the source to the drain. In the p-channel transistor, the current flows from the source to the drain because the holes flow from the source to the drain. It should be noted that the source and the drain of the transistor are not fixed. For example, the source and the drain may be changed according to an applied voltage. Therefore, the present disclosure is not limited by the source and the drain of the transistor. In the following description, the source and the drain of a transistor will be referred to as a first electrode and a second electrode.

A gate signal may swing between a gate-on voltage and a gate-off voltage. The transistor is turned on in response to the gate-on voltage and is turned off in response to the gate-off voltage. In the case of the n-channel transistor, the gate-on voltage may be a gate high voltage VGH, and the gate-off voltage may be a gate low voltage VGL.

Hereinafter, various example embodiments of the present disclosure will be described in detail with reference to the accompanying drawings.

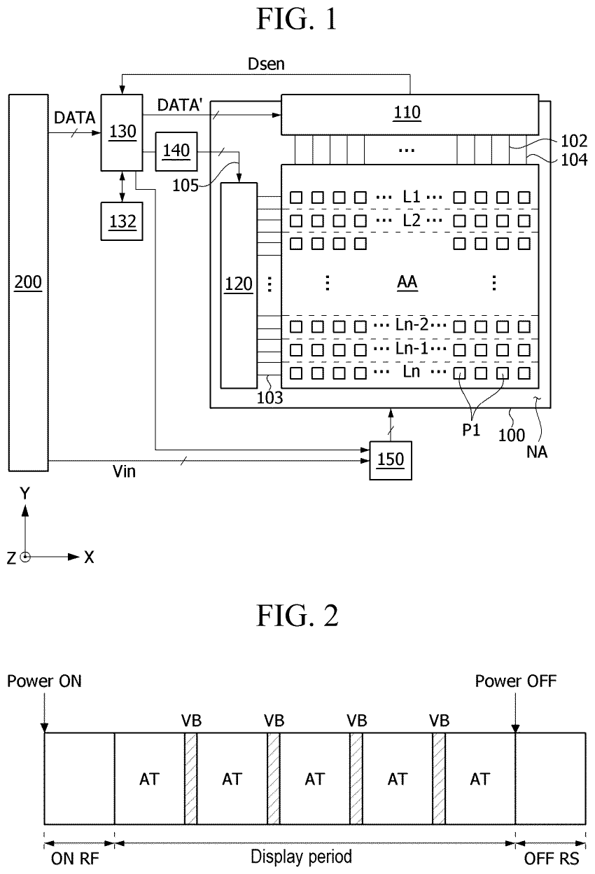

As shown in FIG. 1, a display device according to an example embodiment of the present disclosure may include a display panel 100, a display panel driving circuit 110 and 120 for writing pixel data to pixels P1 of the display panel 100, a power supply 150 that generates power for driving the pixels P1 and the display panel driving circuit 110 and 120, and the like.

The display panel 100 may be a rectangular panel having a breadth (or width) in the X-axis direction, a length in the Y-axis direction, and a thickness in the Z-axis direction, but is not limited thereto. A screen of the display panel 100 may include a display area AA and a non-display area NA outside the display area AA. The display area AA of the display panel 100 may include a pixel array that displays an input image. The pixel array may include a plurality of data lines 102, a plurality of gate lines 103 intersecting the plurality of data lines 102, a plurality of reference lines 104, and the pixels disposed in a matrix. The display panel 100 may further include power lines connected in common to the pixels. The power lines may be connected in common to pixel circuits and may supply a voltage for driving the pixels P1 to the pixels P1.

The plurality of data lines 102 may be disposed in the form of long wires along the Y-axis direction of the display panel 100 and may be electrically connected to data channels of a data driver 110. The plurality of reference lines 104 may be disposed on the display panel in parallel with the plurality of data lines 102 and may be connected to the pixels and sensing channels of the data driver 110. The plurality of gate lines 103 may be disposed in the form of long wires along the X-axis direction of the display panel 100, may intersect the plurality of data lines 102, and may be electrically connected to output terminals of a gate driver 120.

Each of the pixels P1 may be divided into a red sub-pixel, a green sub-pixel, and a blue sub-pixel for color implementation. Each of the pixels may further include a white sub-pixel. Each of the sub-pixels may include a pixel circuit that drives the light-emitting element. Each pixel circuit may be connected to the data line, the gate lines, and the power lines.

The pixel array may include a plurality of pixel lines L1 to Ln. Each of the pixel lines L1 to Ln may include one line of pixels disposed along the X-axis direction in the pixel array of the display panel 100. The pixels disposed in one pixel line may share a plurality of gate lines 103. The sub-pixels disposed along the Y-axis direction in a data line direction may share the same data line 102. One horizontal period 1 H may be a time obtained by dividing one frame period by the total number of pixel lines L1 to Ln.

The display panel 100 may be implemented as a non-transmissive display panel or a transmissive display panel. The transmissive display panel may be applied to a transparent display device in which an image is displayed on a screen and a real object in a background is visible. The display panel 100 may be manufactured as a flexible display panel.

The power supply 150 may adjust a level of a direct-current input voltage Vin that is applied from a host system 200 and may output a voltage for driving the pixel array of the display panel 100 and the display panel driving circuit.

The power supply 150 may include a DC-DC converter. The DC-DC converter may include a charge pump, a regulator, a buck converter, a boost converter, and the like.

The power supply 150 may output a gamma reference voltage, a gate high voltage, a gate low voltage, a pixel driving voltage, a pixel ground voltage, a reference voltage, an integrated circuit (IC) driving voltage, and the like. The voltages that are output from the power supply 150 may be constant voltages (or direct-current voltages). The gamma reference voltage may be supplied to the data driver 110. A dynamic range of a data voltage that is output from the data driver 110 may be determined according to a voltage range of the gamma reference voltage. The dynamic range of the data voltage has a voltage range between a highest grayscale voltage and a lowest grayscale voltage. A voltage level of the data voltage may be selected according to a grayscale value of pixel data.

The gate high voltage and the gate low voltage may be supplied to a level shifter 140 and the gate driver 120. The voltages such as the pixel driving voltage, the pixel ground voltage, and the reference voltage may be supplied to the pixels P1 via the power lines connected in common to the pixels P1. The IC driving voltage may be a driving voltage of a drive IC (source drive IC) in which circuits such as a timing controller 130 and the data driver 110 are embedded.

The power supply 150 may be implemented as a power IC such as a power management integrated circuit (PMIC) or an electronics integrated circuit (ELIC), but is not limited thereto. The power supply 150 may adjust an output voltage under the control of the timing controller 130. For example, when the power supply 150 is connected to the timing controller 130 via a serial interface such as I2C, the timing controller 130 may transmit a command signal including a register set value in a voltage control register of the power supply 150 to the power supply 150 to vary a voltage level of a voltage that is output from the power supply 150. For example, the timing controller 130 may output a control signal to the power supply 150 such that a voltage level of a reference voltage for driving of a sensing part is varied.

The display panel driving circuit 110 and 120 may write pixel data of an input image to the pixels of the display panel 100 under the control of the timing controller 130. The display panel driving circuit 110 and 120 may include the data driver 110 and the gate driver 120. The display panel driving circuit 110 and 120 may further include demultiplexers (DEMUX) disposed between the data driver 110 and the plurality of data lines 102, but embodiments of the present disclosure are not limited thereto. When the demultiplexers are disposed between output terminals of the data driver 110 and the plurality of data lines 102, the number of data channels of the data driver 110 may be reduced.

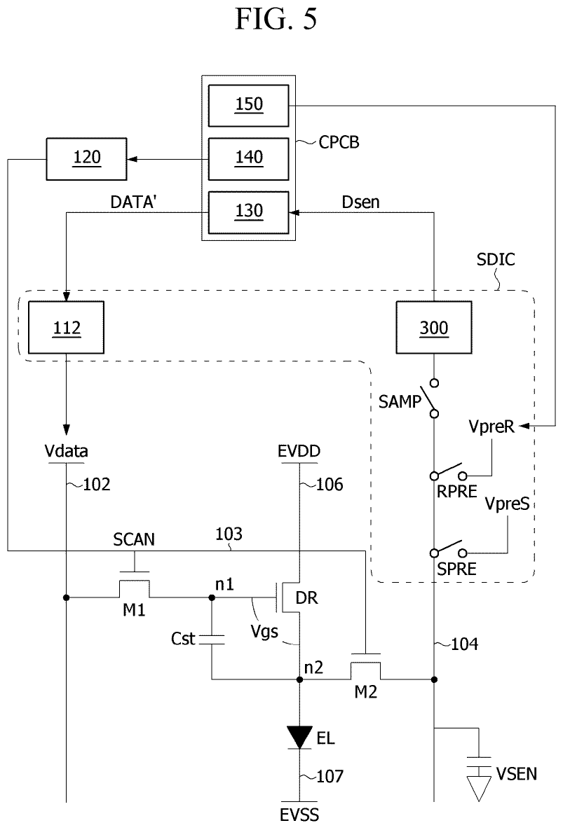

The display device may include a sensing part (FIGS. 5, 300) connected to the sub-pixels. The sensing part 300 may convert a sensing voltage obtained from each sub-pixel via the reference line 104 into a digital signal (hereinafter, referred to as “sensing data”) Dsen and may transmit the sensing data to the timing controller 130. A circuit of the sensing part 300 may be disposed in a sensing channel of the data driver 110.

Touch sensors for sensing a touch input may be disposed on the display panel 100. The touch sensors may be disposed on the display panel 100 as an on-cell type or an add on type, or may be implemented as in-cell type touch sensors that are embedded in the pixel array.

The display panel driving circuit 110 and 120 may further include a touch sensor driver for driving the touch sensors. The touch sensor driver is omitted in FIG. 1. The data driver 110 and the touch sensor driver may be integrated in one drive IC.

The data driver 110 may receive pixel data of an input image received as a digital signal from the timing controller 130 and may output a data voltage. The data driver 110 may include data channels that are electrically connected to the plurality of data lines 102 and output data voltages, and sensing channels that are electrically connected to the plurality of reference lines 104 and receive sensing voltages.

The data channels of the data driver 110 may convert pixel data DATA′ of an input image received from the timing controller 130 into a gamma compensation voltage using a digital-to-analog converter (hereinafter, referred to as “DAC”) and may output a data voltage of the pixel data. The gamma reference voltage may be divided into grayscale-specific gamma compensation voltages through a voltage division circuit. The grayscale-specific gamma compensation voltages may be provided to the DAC of the data driver 110. The data voltage may be output from each of the channels of the data driver 110 via an output buffer.

The sensing channels of the data driver 110 may include an analog-to-digital converter (hereinafter, referred to as “ADC”). The sensing channels may convert the sensing voltage received via each of the plurality of reference lines 104 into digital data using the ADC and may output sensing data Dsen. The sensing data Dsen may be transmitted to the timing controller 130.

The gate driver 120 may be disposed in the non-display area NA on at least one of the right and left sides outside the display area AA in the display panel 100 or at least a part thereof may be disposed within the display area AA.

The gate driver 120 may be disposed in the non-display area NA on both sides of the display panel 100 with the display area AA of the display panel interposed therebetween may supply gate pulses to both sides of the plurality of gate lines 103 by a double feeding method. In another example embodiment, the gate driver 120 may be disposed in the non-display area AA on at least one of the right and left sides of the display panel 100 and may supply gate signals to the plurality of gate lines 103 by a single feeding method. The gate driver 120 may sequentially output the pulses of the gate signals to the plurality of gate lines 103 under the control of the timing controller 130. The gate driver 120 may shift the pulses of the gate signals using a shift register, thereby sequentially supplying these signals to the plurality of gate lines 103. A plurality of gate signals may be applied to the pixel circuit. In this case, the gate driver 120 may include a plurality of shift registers that output the pulses of the gate signals.

The timing controller 130 may receive digital video data of an input image and a timing signal synchronized with the data from the host system 200. The timing controller 130 may generate a data timing control signal for controlling an operation timing of the data driver 110 and a gate timing control signal for controlling an operation timing of the gate driver 120 on the basis of the timing signal received from the host system 200. The timing controller 130 controls the operation timing of the display panel driving circuit to synchronize the driver 110 and the gate driver 120.

The gate timing control signal output from the timing controller 130 may be input to the shift register of the gate driver 120 via the level shifter 140. The level shifter 140 may convert the gate timing control signal received from the timing controller 130 to have a swing width between a gate high voltage and a gate low voltage and may provide the converted gate timing control signal to the gate driver 120 via clock lines 105.

The gate timing control signal output from the level shifter 140 may include a start signal, a clock, a line selection signal, a reset signal, and the like, but embodiments of the present disclosure are not limited thereto. The gate driver 120 may output the pulses of the gate signals for writing the pixel data to the sub-pixels in a display period in response to the gate timing control signal input from the level shifter 140, and may output the pulses of the gate signals for sensing electrical characteristics of the sub-pixels in a sensing period.

According to an example embodiment, the timing controller 130 may modulate the gate timing control signal to adjust a pulse width of a gate clock signal of the level shifter 140.

The host system 200 may convert the resolution of an image signal from a video source to match the resolution of the display panel 100 and may transmit the image signal to the timing controller 130 along with the timing signal.

The sensing part (FIGS. 5, 300) may sequentially sense the sub-pixels of the display area AA in units of line in a preset sensing period under the control of the timing controller 130 to sense electrical characteristics of the light-emitting element and/or the driving transistor in all sub-pixels, for example, a deviation in gate-source voltage between the driving transistors, a deviation in resistance between the reference lines, mobility, and a threshold voltage. The level shifter 140 may output the gate clock signal with an adjusted pulse width to the gate driver 120 according to a deviation in resistance between the reference lines 104 to which the plurality of sub-pixels P1 are connected.

The timing controller 130 may determine an electrical characteristic value or deviation in resistance of a circuit element included in the corresponding sub-pixel, for example, light-emitting element and the driving transistor on the basis of the sensing data Dsen received by the sensing part 300.

The timing controller 130 may derive compensation values for compensating for the optical and electrical characteristics of each sub-pixel on the basis of the sensing data Dsen. For example, the timing controller 130 may execute a preset compensation algorithm to derive compensation values for compensating for the optical and electrical characteristics of the pixels on the basis of the sensing data Dsen or may input the sensing data Dsen to a look-up table (LUT) stored in a memory 132 to derive compensation values output from the look-up table.

In the look-up table, compensation values corresponding to initial optical and electrical characteristics measured by sub-pixel in an aging process and an inspection process of the display panel are set by sub-pixel. The compensation values stored in the look-up table may be updated according to sensing values reflecting deterioration accumulated as the driving time of the sub-pixels is longer. A compensation circuit of the timing controller 130 may add or multiply a compensation value derived from the look-up table to the pixel data of the input image, thereby compensating for a deviation or change in electrical characteristic of the light-emitting element and/or the driving transistor in each of the sub-pixels.

The memory 132 may store driving setting timing information of the display panel driving circuit 110 and 120, the look-up table for deriving the compensation values on the basis of sensing results of the sub-pixels, a program code of a compensation algorithm for improving image quality, and the like. The memory 132 may include a non-volatile memory and a volatile memory. The non-volatile memory may include one or more of readable and writable memories, for example, a NAND flash memory, a NOR flash memory, and an electrically erasable programmable read-only memory (EEPROM). The NAND flash memory may be a single level cell (SLC) type. The volatile memory may include one or more a dynamic RAM (DRAM), a static RAM (SRAM), a synchronous dynamic RAM (SDRAM), and a double data rate SDRAM (DDR SDRAM).

As shown in FIG. 2, the sensing part 300 may be driven in a sensing period set in at least one of a power-on sequence in which power starts to be applied to the display device and a power-off sequence, and may sense the electrical characteristics of the sub-pixels. The sensing part 300 may sense the electrical characteristics of the sub-pixels in a vertical blank interval VB between normal display periods AT within the display period. In the sensing period, the sensing data Dsen output from the sensing channels of the data driver 110 may be transmitted to the timing controller 130.

In FIG. 2, “ON RF” represents the sensing period of the sub-pixels in the power-on sequence. “OFF RS” represents the sensing period of the sub-pixels in the power-off sequence. In the sensing period ON RF of the power-on sequence, the mobility of the driving transistor disposed in each of the sub-pixels may be sensed. In the sensing period OFF RS of the power-off sequence, the mobility of the driving transistor disposed in each of the sub-pixels may be sensed. Further, in the sensing period ON RF of the power-on sequence or the sensing period OFF RS of the power-off sequence, a deviation in gate-source voltage between the transistors of the sub-pixels or a deviation in resistance between the reference lines to which the sub-pixels are connected may be sensed. The sensing of a deviation in resistance between the reference lines that will be hereinafter described in an example embodiment may be performed after sensing of a threshold voltage, but embodiments of the present disclosure are not limited thereto.

The power-off sequence OFF RS may be a process in which power is turned off in a predetermined order when a user's command to turn on a power-off switch of the display device is received. The timing controller 130, the data driver 110, and the gate driver 120, and the sensing part 300 may be further driven for a predetermined time after the power-off switch is turned on in the power-off sequence OFF RS, and may be stopped from being driven when the output of the power supply is blocked after the electrical characteristics of the driving transistor and/or the light-emitting element in each of the sub-pixels and the deviation in resistance between the reference lines are sensed.

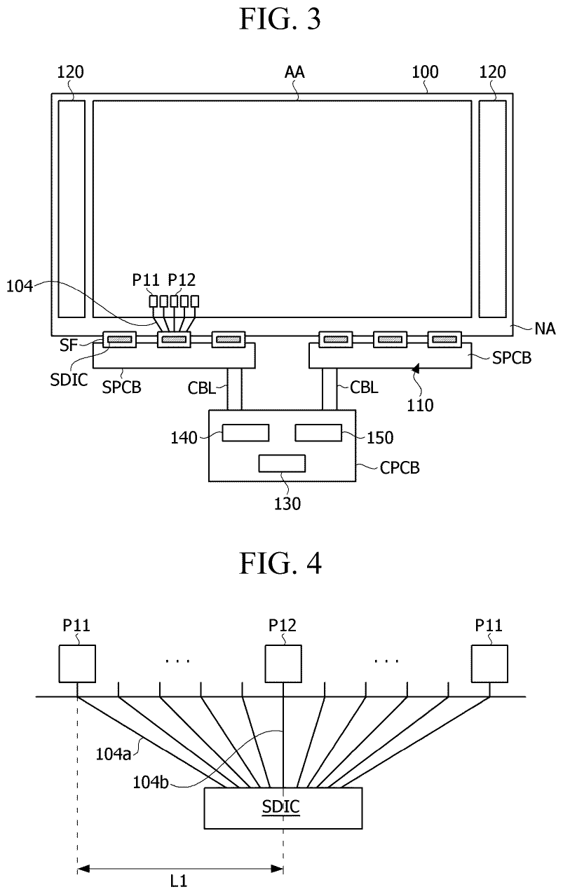

As shown in FIGS. 3 and 4, the data driver 110 may be implemented by a chip on film (COF) method. In this case, a plurality of data driving elements SDIC functioning as the data driver 110 may be mounted on flexible films SF, and one end of each of the flexible films SF may be bonded to a source printed circuit board SPCB and the other end thereof may be bonded to the display panel 100.

The timing controller 130 may be disposed on a control printed circuit board CPCB. The level shifter 140 and the power supply 150 may be further disposed on the control printed circuit board CPCB. The source printed circuit board SPCB may be connected with the control printed circuit board CPCB through a connecting cable CBL.

According to an example embodiment, each of the plurality of data driving elements SDIC may include a plurality of link wires that radially spread toward the display panel. A wire disposed at an edge among the plurality of link wires may be spaced from the data driving element at a first distance L1 in the horizontal direction. As the number of link wires is greater, the first distance L1 may be increased.

The link wires may be the reference lines 104 that are connected to the pixel circuits. The link wires may include a center wire 104b disposed at the center of the data driving element SDIC and an edge wire 104a disposed at the edge of the data driving element SDIC. A second sub-pixel P12 to which the center wire 104b is connected may have resistance smaller than a first sub-pixel P11 to which the edge wire 104a is connected. The first sub-pixel P11 may be connected to a reference line disposed on an outermost side among a plurality of reference lines connected to the data driving element SDIC. The second sub-pixel P12 may be connected to a reference line disposed at a most center among the plurality of reference lines. The first sub-pixel P11 to which the edge wire 104a is connected may have large resistance because the length of the wire is relatively long. The timing controller 130 may output a control signal to the level shifter 140 such that the pulse width of the gate clock signal is adjusted according to a deviation in resistance between the reference lines to which the first sub-pixel P11 and the second sub-pixel P12 are connected.

The gate-source voltage of the driving transistor of the second sub-pixel P12 having small resistance may be greater than the gate-source voltage of the driving transistor of the first sub-pixel P11. Accordingly, when the pixels are driven, the luminance of the second sub-pixel P12 may be higher than the luminance of the first sub-pixel P11. As a result, stripes in the vertical direction may be observed within the panel.

FIG. 5 is a circuit diagram showing the sensing part electrically connected to the pixel circuit according to an example embodiment of the present disclosure. The pixel circuit and the sensing part are not limited to those shown in FIG. 5. In FIG. 5, “SDIC” represents a data driving element in which the circuit of the data driver 110 is integrated.

As shown in FIG. 5, the pixel circuit includes a light-emitting element EL, a driving transistor DR, a storage capacitor Cst, a first transistor M1, and a second transistor M2.

The pixel circuit may include a data line 102, a gate line 103, a reference line 104, a first constant voltage node 106 to which a pixel driving voltage EVDD is applied, and a second constant voltage node 107 to which a pixel ground voltage EVSS is applied. The constant voltage nodes 106 and 107 may be connected to the power lines connected in common to the pixels. The pixel driving voltage EVDD may be set to a voltage at which the driving transistor DR operates in a saturation region. The pixel driving voltage EVDD may be a voltage higher than a maximum voltage (or a white grayscale voltage) of a data voltage Vdata. The pixel ground voltage EVSS may be a voltage lower than a minimum voltage (or a black grayscale voltage) of the data voltage Vdata.

Reference voltages VpreR and VpreS may include a reference voltage VpreR for driving and a reference voltage VpreS for sensing. The reference voltage VpreR for driving may be set to a voltage higher than the reference voltage VpreS for sensing. For example, the reference voltage VpreR for driving may be 2 [V] and the reference voltage VpreS for sensing may be a ground voltage GND or 0 [V], but embodiments of the present disclosure are not limited thereto. A voltage level of the reference voltage VpreR for driving according to an example embodiment may be variable.

The light-emitting element EL may be an OLED, but is not limited thereto. The light-emitting element may include an anode electrode, a cathode electrode, and a light-emitting layer disposed between these electrodes.

The driving transistor DR may generate a current according to a gate-source voltage Vgs and drive the light-emitting element EL. The gate-source voltage Vgs of the driving transistor DR is the same as a voltage between a first node n1 and a second node n2. The driving transistor DR may include a gate electrode connected to the first node n1, a first electrode connected to the first constant voltage node 106, and a second electrode connected to the second node n2. The pixel driving voltage EVDD may be applied to the first constant voltage node 106. The storage capacitor Cst may be connected between the first node n1 and the second node n2, and may be charged with the gate-source voltage of the driving transistor DR.

The first transistor M1 may be connected between the data line 102 and the first node n1, and may be turned on in response to a gate on voltage of a gate signal SCAN. When the first transistor M1 is turned on, the data line 102 may be electrically connected to the first node n1. The first transistor M1 may include a gate electrode connected to the gate line 103 to which the gate signal SCAN is applied, a first electrode connected to the data line 102, and a second electrode connected to the first node n1.

The second transistor M2 may be connected between the second node n2 and the reference line 104, and may be turned on in response to the gate on voltage of the gate signal SCAN. According to an example embodiment, the first transistor M1 and the second transistor M2 may be connected to the same gate line 103. Accordingly, the first transistor M1 and the second transistor M2 may be turned on simultaneously in response to the gate on voltage. However, embodiments of the present disclosure are not limited thereto. For example, the first transistor M1 and the second transistor M2 may be connected to different gate lines.

When the second transistor M2 is turned on, the reference line 104 may be electrically connected to the second node n2. The second transistor M2 may include a gate electrode connected to the gate line 103 to which the gate signal SCAN is applied, a first electrode connected to the second node n2, and a second electrode connected to the reference line 104.

The data driver 110 may include a plurality of data channels and a plurality of sensing channels. In the data channels, the pixel data of the input image received from the timing controller 130 may be input to the DAC of the data channel 112 and the data voltage Vdata of the pixel data may be output in the display period. The sensing channels may include the sensing part 300. The sensing part 300 may be electrically connected to the pixel circuit via the reference line 104.

The sensing part 300 may include a sampling switch SAMP, a first reference voltage switch RPRE, a second reference voltage switch SPRE, and an ADC. The switches SAMP, RPRE, and SPRE of the sensing part 300 may be implemented as logic circuits in the data driver 110 or transistors that are turned on and off under the control of the timing controller 130.

When the sampling switch SAMP is turned on, the reference line 104 may be electrically connected to the ADC of the sensing part 300. The first reference voltage switch RPRE may be turned on in the display period and may supply the reference voltage VpreR for driving to the reference line 104. The second reference voltage switch SPRE may be turned on in the sensing period and may supply the reference voltage VpreS for sensing to the reference line 104.

According to an example embodiment, while a structure in which the timing controller 130 is connected to one pixel circuit has been shown, the timing controller 130 may be connected to a plurality of sub-pixels disposed in the horizontal direction and may sense a deviation in resistance between the reference lines connected to the sub-pixels.

In the pixel circuit of the second sub-pixel P12 connected to the reference line 104 having relatively low resistance, during initialization according to normal driving, the voltage of the second node n2 is quickly initialized from 8 V to 2.5 V. Meanwhile, in the pixel circuit of the first sub-pixel P11 connected to the reference line 104 having high resistance, even when an initialization voltage of 2.5 [V] is applied to the second node n2, the voltage of the second node n2 does not drop to 2.5 [V] due to a deviation in resistance, is maintained at about 3 [V], and is not completely initialized. Accordingly, because the gate-source voltage Vgs of the driving transistor DR of the second sub-pixel P12 is greater than the gate-source voltage Vgs of the driving transistor DR of the first sub-pixel P11, luminance may be nonuniform.

The timing controller 130 may receive a sensing voltage of the reference line 104 connected to the first sub-pixel P11 and a sensing voltage of the reference line 104 connected to the second sub-pixel P12 from the sensing part 300. The sensing voltage of the reference line 104 may be stored in a sensing capacitor VSEN.

The timing controller 130 may output a control signal to the level shifter 140 such that a pulse width of a gate clock signal is adjusted according to the sensing voltage. The level shifter 140 may output the gate clock signal with the pulse width adjusted according to the control signal of the timing controller 130 to the gate driver 120. The gate driver 120 may apply a gate signal adjusted according to the gate clock signal to the first transistor M1 and/or the second transistor M2.

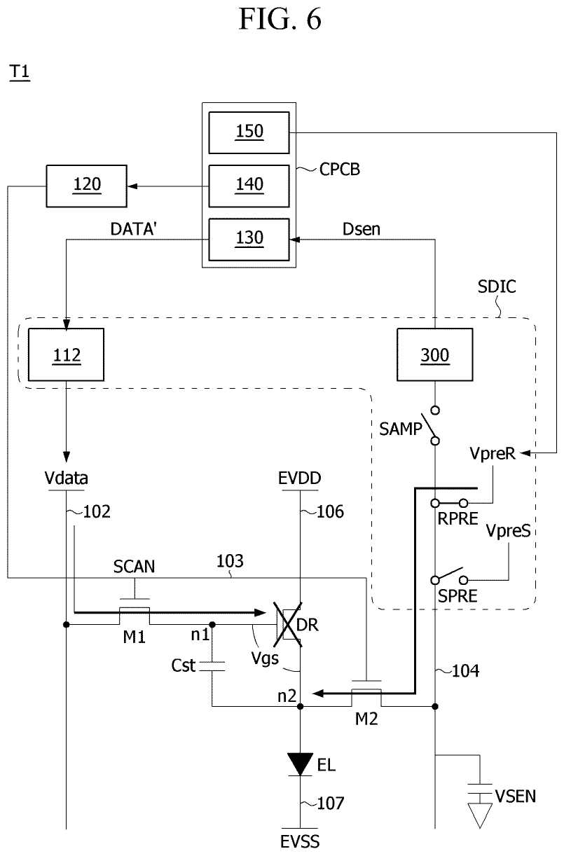

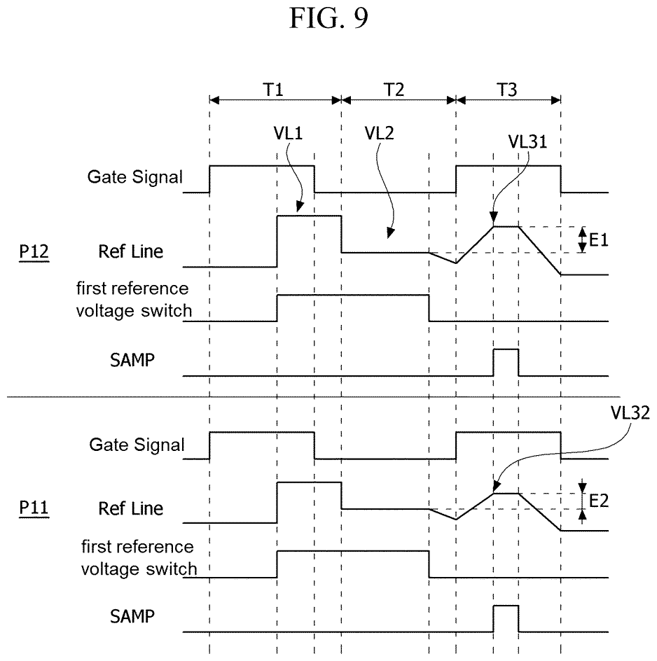

FIGS. 6 to 8 are diagrams showing a process of sensing reference lines according to an example embodiment of the present disclosure. FIG. 9 is a waveform chart of gate signals and voltages that are input to the pixel circuits of the first sub-pixel and the second sub-pixel according to an example embodiment of the present disclosure.

As shown in FIG. 6, in an initialization period T1 of a reference line sensing mode, the first transistor M1 and the second transistor M2 may be turned on simultaneously in response to the gate on voltage. Accordingly, the data voltage Vdata for sensing may be applied to the first node n1 of the driving transistor DR. Further, because the first reference voltage switch RPRE is turned on, the reference voltage VpreR for driving may be applied to the second node n2 of the driving transistor DR.

During the sensing of the reference lines, the reference voltage VpreR for driving may be set to be lower than an OLED driving voltage. When the reference voltage VpreR for driving is equal to the OLED driving voltage, the light-emitting element EL may be turned on. The reference voltage VpreR for driving at a first voltage level may be 7 [V], and the data voltage Vdata for sensing may be 1 [V]. However, the voltage levels of the reference voltage VpreR for driving and the data voltage Vdata for sensing are not limited thereto.

According to an example embodiment, the reference voltage VpreR for driving may be greater than the data voltage Vdata for sensing. Accordingly, the driving transistor DR may not be turned on.

The data voltage Vdata for sensing and the reference voltage VpreR for driving may be applied to both ends of the storage capacitor Cst, respectively, and a voltage having a difference in voltage level between the data voltage Vdata for sensing and the reference voltage VpreR for driving may be charged in the storage capacitor Cst.

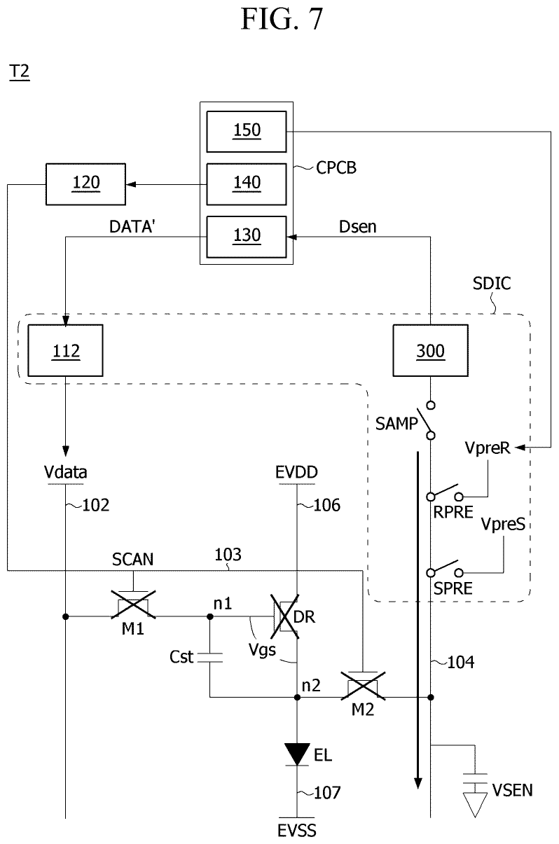

As shown in FIG. 7, in a floating period T2 of the reference line sensing mode, the first transistor M1 and the second transistor M2 may be turned off in response to a gate off voltage. In this case, the first reference voltage switch RPRE may be maintained in the turn-on state. The reference voltage VpreR for driving may be varied to a second voltage level lower than the first voltage level. The second voltage level of the reference voltage VpreR for driving may be 2.5 [V], but embodiments of the present disclosure are not limited thereto. The second voltage level may be higher than the voltage level of the reference voltage for sensing.

The reference voltage VpreR for driving at the second voltage level may be charged only in the reference line 104 because the second transistor M2 is in the turn-off state. After reference line 104 is charged with the reference voltage VpreR for driving at the second voltage level, the first reference voltage switch RPRE may be turned off. Accordingly, the reference line 104 may be floated. The voltage charged in the reference line 104 may be stored in the sensing capacitor VSEN or a line capacitor.

According to an example embodiment, the timing controller 130 may apply a control signal to the power supply 150 such that the power supply 150 changes the voltage level of the reference voltage VpreR for driving, for example, lowers the reference voltage VpreR for driving to the second voltage level in the floating period T2.

However, embodiments of the present disclosure are not limited thereto. For example, the reference voltage VpreR for driving may not be lowered to the second voltage level, and the second reference voltage switch SPRE may be turned on to charge the reference voltage VpreS for sensing in the reference line 104. The reference voltage VpreS for sensing may be 0 [V], but embodiments of the present disclosure are not limited thereto.

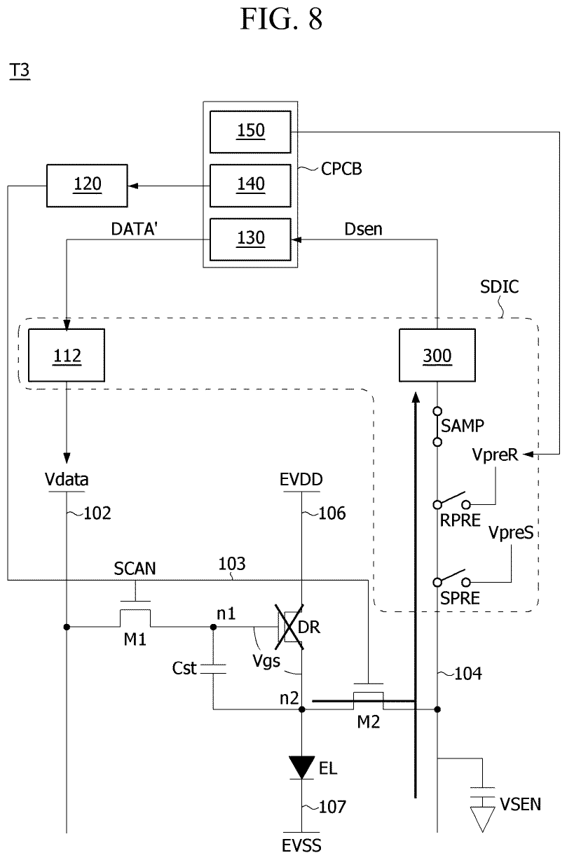

As shown in FIG. 8, in a sensing period T3 of the reference line sensing mode, the first transistor M1 and the second transistor M2 may be turned on response to the gate on voltage. Accordingly, the second node n2 and the reference line 104 may be electrically connected to sense the voltage of the reference line 104. The sensing voltage charged in the sensing capacitor VSEN may be different according to a magnitude of resistance of the reference line 104. Because the reference line 104 is in the floating state, the voltage of the reference line 104 may be increased by a voltage charged in the storage capacitor Cst.

According to an example embodiment, in the initialization period T1, the data voltage Vdata for sensing may not be applied, and only the reference voltage VpreR for driving at the first voltage level may be applied to the second node n2. In this case, the voltage of the reference line 104 may be increased by the voltage charged in the second node n2. The increased sensing voltage of the reference line 104 may be stored in the sensing capacitor VSEN.

In the sensing period T3, the sampling switch SAMP may be turned on, and the sensing part 300 may receive the sensing voltage of the reference line 104 stored in the sensing capacitor VSEN. The sensing part 300 may convert the sensing voltage as an analog signal into a digital signal and may transmit the digital signal to the timing controller 130.

When the resistance of the reference line 104 is large, a width of an increase in voltage in the sensing period may be small. In contrast, when the resistance of the reference line 104 is small, the width of the increase in voltage may be relatively large.

As shown in FIG. 9, in the case of the second sub-pixel P12 disposed at the center of the data driving element SDIC, it can be confirmed that a sensing voltage VL31 is relatively higher than a second voltage level VL2 because the resistance of the reference line 104 is small (E1). In this case, the sensing voltage VL31 of the reference line may be lower than a first voltage level VL1.

In contrast, in the case of the first sub-pixel P11 disposed at the edge of the data driving element SDIC, it can be confirmed that a sensing voltage VL32 has no significant difference from the second voltage level VL2 (E2). In this way, when a deviation in resistance occurs, a difference in gate-source voltage may occur during the operation of the display, resulting in a difference in luminance.

In an example embodiment, while a case where the deviation in resistance between the respective sub-pixels is sensed has been illustrated, but embodiments of the present disclosure are not limited thereto. For example, in the case of three-color (for example, W/R/B) driving, a data voltage of green (G) may be floated, only data voltages of white (W)/red (R)/blue (B) may be applied, and then, a deviation in resistance between the reference lines may be sensed. Further, in the case of four-color driving, all data voltages of R/W/B/G may be applied, and a deviation in resistance between the reference lines may be sensed.

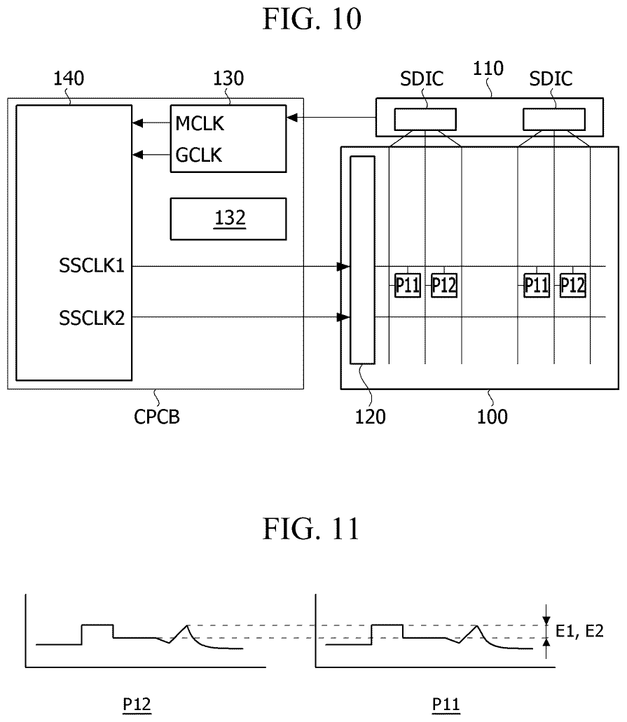

FIG. 10 is a diagram showing a connection structure of a timing controller, a level shifter, a gate driving circuit, and a display panel according to an example embodiment of the present disclosure.

As shown in FIG. 10, the timing controller 130 may sense the reference lines 104 of the pixel circuits of the first sub-pixel P11 and the second sub-pixel P12 of the data driving element SDIC connected to the same gate line, and when a deviation between the reference line 104 occurs, may adjust the width of the gate clock signal of the level shifter 140 to compensate for the deviation.

When the width of the gate clock signal is widened, a charging time is extended, and even when the resistance of the reference line 104 is large, the initialization of the second node n2 may be performed. Accordingly, the gate-source voltages of the driving transistors in the sub-pixels having a deviation in resistance may be made similar.

The timing controller 130 may perform control such that the pulse width of the gate clock signal is output without change when the difference in sensing voltage between the reference lines 104 of the first sub-pixel P11 and the second sub-pixel P12 is smaller than or equal to a predetermined deviation, for example, a deviation critical value stored in the memory 132.

The timing controller 130 may output a control signal to the level shifter 140 such that the pulse width of the gate clock signal is increased according to pulse width information stored in the memory 132 when the difference or deviation in sensing voltage between the reference lines 104 of the first sub-pixel P11 and the second sub-pixel P12 is greater than the predetermined deviation, for example, the deviation critical value.

In the memory 132, deviation critical value information and pulse width information may be stored. The pulse width information may include adjustable width information of the gate clock signal. For example, the pulse width information may include ten pieces of pulse width modulation information obtained by modulating the width of the gate clock in units of several to tens of μs. Each piece of pulse width modulation information may be a pulse width satisfying a condition that line dim does not occur during driving. The number of pieces of pulse width modulation information is not limited.

The timing controller 130 may output a control signal to the level shifter 140 such that the pulse width of the gate clock signal SSCLK1 and SSCLK2 is adjusted according to the ten pieces of pulse width modulation information stored in the memory 132.

The timing controller 130 may output a control signal to the level shifter 140 such that a rising edge timing of the gate clock signal is adjusted. For example, the timing controller 130 may modulate a cycle of a first control clock signal GCLK and/or second control clock signal MCLK and may transmit the first control clock signal GCLK and/or second control clock signal MCLK to the level shifter 140. When a rising edge of the first control clock signal GCLK is earlier, the width of the corresponding gate clock may be increased. According to an example embodiment, an output timing of the rising edge may be adjusted to be earlier to increase the width of the gate clock. Because adjustment of a falling edge may affect a charging time in a normal driving mode, the falling edge may not be preferably modulated.

As shown in FIG. 11, when the reference lines are sensed again after the pulse width of the gate clock signal is adjusted, a turn-on time of the second transistor M2 is longer in the sensing period T3. For this reason, the voltage of the reference line 104 connected to the first sub-pixel P11 may be further increased. Accordingly, because a sufficient charging time is secured with adjustment to a predetermined gate clock width, the voltages of the reference lines 104 of the first sub-pixel P11 and the second sub-pixel P12 may be made similar.

The timing controller 130 may adjust the pulse width according to information on pulse widths of a plurality of gate clock signals stored in the memory and may sense a deviation between the reference lines. The timing controller may select the pulse width of the gate clock signal at which a voltage deviation does not occur, among the pulse widths of the plurality of gate clock signals.

However, embodiments of the present disclosure are not limited thereto. For example, matching pulse width information may be stored in a look-up table format according to a voltage difference between the reference lines. Accordingly, the timing controller 130 may select a pulse width of a gate clock matching a sensed voltage deviation between the reference lines.

The timing controller 130 may store the selected pulse width information of the gate clock signal in the memory 132. Accordingly, during driving of the display, the display may be driven according to the stored pulse width of the gate clock signal.

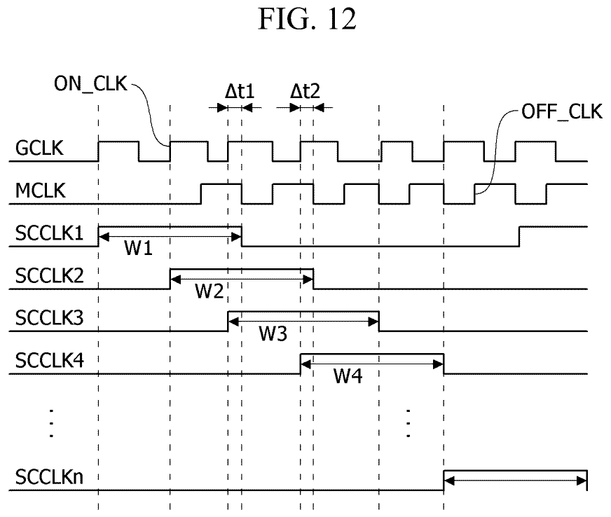

As shown in FIG. 12, the level shifter may generate a plurality of gate clock signals SCCLK1 to SCCLKn on the basis of first and second control clock signals GCLK and MCLK.

The first control clock signal GCLK may include on-clocks ON_CLK that have the same amplitude and are shifted at regular intervals, and the second control clock signal MCLK may include off-clocks OFF_CLK that have the same amplitude and are shifted at regular intervals. The plurality of gate clock signals SCCLK1 to SCCLKn may be generated by a logic operation of the first and second control clock signals GCLK and MCLK.

The on-clocks ON_CLK supplied from the first control clock signal GCLK may indicate rising timings of the gate clock signals SCCLK1 to SCCLKn, and the off-clocks OFF_CLK supplied from the second control clock signal MCLK may indicate falling timings of the gate clock signals SCCLK1 to SCCLKn. Accordingly, the gate clock signals SCCLK1 to SCCLKn that sequentially rise in synchronization with the on-clocks ON_CLK of the first control clock signal GCLK and sequentially fall in synchronization with the off-clocks OFF_CLK of the second control clock signal MCLK may be generated.

Because pulses of the first control clock signal GCLK and the second control clock signal MCLK have the same amplitude and are shifted at regular intervals, the gate clock signals SCCLK1 to SCCLKn generated on the basis of the first control clock signal GCLK and the second control clock signal MCLK have the same amplitude and are shifted at regular intervals. That is, the gate clock signals SCCLK1 to SCCLKn may be signals that have the same waveform and are phase-shifted with respect to each other.

In an embodiment, the gate clock signals SCCLK1 to SCCLKn may be signals phase-shifted sequentially. For example, the second gate clock signal SCCLK2 may be a signal that has the same waveform as and is phase-shifted for a ½ cycle with respect to the first gate clock signal SCCLK1, but is not limited thereto.

The on-clocks ON_CLK of the first control clock signal GCLK determine rising times of gate on voltage periods of the corresponding gate clock signals SCCLK1 to SCCLKn, and the off-clocks OFF_CLK of the second control clock signal MCLK determine falling times of gate on voltage periods of the corresponding gate clock signals SCCLK1 to SCCLKn. Accordingly, by adjusting pulse timings of the control clock signals GCLK and MCLK, lengths of the gate on voltage periods, that is, pulse widths of the gate clock signals SCCLK1 to SCCLKn can be individually controlled.

For example, the timing controller 130 may increase the pulse widths of the corresponding gate clock signals SCCLK1 to SCCLKn by controlling the pulse timing of the first control clock signal GCLK to be advanced. For example, the pulse timing of the first control clock signal GCLK corresponding to a third gate clock signal SCCLK3 may be advanced for Δt1.

Further, the timing controller may advance the pulse timing of the first control clock signal GCLK corresponding to a fourth gate clock signal SCCLK4 for Δt2.

Accordingly, pulse widths W3 and W4 of the third and fourth gate clock signals SCCLK3 and SCCLK4 may be each greater than each of pulse widths W1 and W2 of first and second gate clock signals SCCLK1 and SCCLK2. According to an example embodiment, the pulse width of the gate clock signal may be different according to a characteristics deviation between the sub-pixels disposed in a horizontal line.

According to an example embodiment, a temperature sensor may be further provided, and the timing controller may receive a temperature sensor value. During power-off, the timing controller may confirm an ambient environment temperature through the temperature sensor, and pulse width modulation information by environment temperature may be set in the look-up table. Accordingly, the timing controller may select an appropriate pulse width by temperature.

The display device according to an example embodiment of the present disclosure may include a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an e-book, a portable multimedia player (PMP), a personal digital assistant (PDA), an MP3 player, a mobile medical device, a desktop PC, a laptop PC, a net book computer, a workstation, a navigation, an in-vehicle navigation, an in-vehicle display device, an in-vehicle device, a theater device, a theater display device, a television, a wallpaper device, a signage device, a gaming device, a laptop, a monitor, a camera, a camcorder, a consumer electronics device, and the like.

The descriptions of the problem to be solved, the means to solve the problem, and the effect described above do not specify the essential features of the claims, and the scope of the claims is not limited by what is described in the specification.

Although example embodiments of the present disclosure have been described in more detail with reference to the accompanying drawings, the present disclosure is not necessarily limited to such embodiments, and may be variously modified without departing from the technical spirit of the present disclosure. Therefore, the example embodiments disclosed in the present disclosure are provided for illustrative purposes only and are not intended to limit the technical concept of the present disclosure, and the scope of the technical concept of the present disclosure is not limited thereto. Therefore, it should be understood that the example embodiments described above are illustrative in all aspects and do not limit the present disclosure. A scope of protection of the present disclosure may be construed on the basis of the following claims and their equivalents, and all technical concepts within the equivalent scope thereof should be construed as falling within the scope of the present disclosure.

### LIST OF REFERENCE NUMBERS

100: Display panel
102: Data line
103: Gate line
104: Reference line
110: Data driver
120: Gate driver
130: Timing controller
132: Memory
140: Level shifter
150: Power supply

What is claimed is:

1. A display device, comprising:
a display panel in which a plurality of data lines, a plurality of gate lines, a plurality of reference lines, and a plurality of sub-pixels are disposed;
a data driver connected to the plurality of data lines and the plurality of reference lines;
a gate driver connected to the plurality of gate lines;
a level shifter configured to output a gate clock signal to the gate driver; and
a timing controller configured to control the data driver and the gate driver,
wherein the level shifter is configured to output the gate clock signal with an adjusted pulse width to the gate driver according to a deviation in resistance between the reference lines respectively to which the plurality of sub-pixels are connected.

2. The display device according to claim 1, wherein the plurality of sub-pixels include:
a first sub-pixel connected to a reference line disposed on an outermost side among a plurality of reference lines connected to a data driving element of the data driver; and
a second sub-pixel connected to another reference line disposed at a most center among the plurality of reference lines, and
wherein the timing controller is further configured to output a control signal to the level shifter such that the pulse width of the gate clock signal is adjusted according to a deviation in resistance between the reference lines respectively to which the first sub-pixel and the second sub-pixel are connected.

3. The display device according to claim 1, wherein the timing controller is further configured to output a control signal to the level shifter such that a rising edge timing of the gate clock signal is adjusted.

4. The display device according to claim 1, wherein each of the sub-pixels includes:
a driving transistor having a first node and a second node connected to a light-emitting element;
a first transistor between the first node of the driving transistor and a corresponding data line among the plurality of data lines;
a second transistor connected to the second node of the driving transistor and a corresponding reference line among the plurality of reference lines;
a storage capacitor connected between the first node and the second node;
a first reference voltage switch configured to apply a reference voltage for driving to the corresponding reference line; and
a second reference voltage switch configured to apply a reference voltage for sensing to the corresponding reference line.

5. The display device according to claim 4, wherein, during an operation in a reference line sensing mode, an operation of the sub-pixel includes:
an initialization period during which a reference voltage for driving at a first voltage level is charged in the second node;
a floating period during which a reference voltage for driving at a second voltage level lower than the first voltage level is charged in the corresponding reference line to float the corresponding reference line; and
a sensing period during which the second node and the corresponding reference line are electrically connected to sense a voltage of the corresponding reference line.

6. The display device according to claim 5, wherein, in the initialization period, the first reference voltage switch and the second transistor are turned on to apply the reference voltage for driving at the first voltage level to the second node.

7. The display device according to claim 6, wherein:
a data voltage for sensing is applied to the first node in the initialization period; and
the first voltage level is higher than a voltage level of the data voltage for sensing.

8. The display device according to claim 5, wherein, in the floating period:
the second transistor is turned off; and
after the reference voltage for driving is changed to the second voltage level and charged in the corresponding reference line, the first reference voltage switch is turned off.

9. The display device according to claim 8, wherein the second voltage level is higher than a voltage level of the reference voltage for sensing.

10. The display device according to claim 5, wherein, in the sensing period:
the second transistor is turned on to connect the second node and the corresponding reference line; and
a sensing voltage charged in a sensing capacitor of the corresponding reference line is different according to a magnitude of resistance of the corresponding reference line.

11. The display device according to claim 8, further comprising:
a power supply configured to apply the reference voltage for driving to the data driver,
wherein the timing controller is further configured to apply a control signal to the power supply such that the power supply changes a voltage level of the reference voltage for driving in the floating period.

12. The display device according to claim 2, wherein the timing controller is further configured to increase the pulse width of the gate clock signal when a deviation in sensing voltage between the reference lines respectively to which the first sub-pixel and the second sub-pixel are connected is greater than a predetermined deviation.

13. The display device according to claim 12, further comprising:
a memory configured to store a deviation critical value and pulse width information of the gate clock signal,
wherein the timing controller is further configured to increase the pulse width of the gate clock signal according to the pulse width information stored in the memory when the deviation in sensing voltage between the reference lines respectively to which the first sub-pixel and the second sub-pixel are connected is greater than the deviation critical value.

14. The display device according to claim 6, wherein the first transistor is turned on in the initialization period, and
wherein in the initialization period, a data voltage for sensing is not applied to the first node, and only the reference voltage for driving at the first voltage level is applied to the second node.

15. The display device according to claim 8, wherein the first transistor is turned off in the floating period, and
wherein the first transistor is turned on in the sensing period.

16. The display device according to claim 2, wherein the timing controller is configured to output the pulse width of the gate clock signal without change when a deviation in sensing voltage between the reference lines to which the first sub-pixel and the second sub-pixel are connected is smaller than or equal to a predetermined deviation.

17. The display device according to claim 4, wherein during an operation in a reference line sensing mode, an operation of the sub-pixel includes:
an initialization period during which the reference voltage for driving at a first voltage level is charged in the second node,
a floating period during which the second reference voltage switch is turned on to charge the reference voltage for sensing in the reference line, and
a sensing period during which the second node and the reference line are electrically connected to sense a voltage of the reference line.

18. The display device according to claim 1, wherein the level shifter is configured to output a plurality of gate clock signals having a same amplitude and shifted at regular intervals on the basis of a first control clock signal and a second control clock signal outputted from the timing controller.

19. The display device according to claim 18, wherein the first control clock signal includes on-clocks that have a same amplitude and are shifted at regular intervals, and the second control clock signal includes off-clocks that have a same amplitude and are shifted at regular intervals.

20. The display device according to claim 18, wherein the timing controller is configured to increase pulse widths of corresponding gate clock signals by controlling a pulse timing of the first control clock signal to be advanced.
